(19) United States
(12) Patent Application Publication
(10) Pub. No.: US 2022/0157502 A1
(43) Pub. Date: May 19, 2022

(54) MAGNETIC VEHICLE TIRE PROTECTION SYSTEM

(71) Applicant: Sekou Toussaint, Ormond Beach, FL (US)

(72) Inventor: Sekou Toussaint, Ormond Beach, FL (US)

(73) Assignee: Sekou Osaze Toussaint, Ormond Beach, FL (US)

(21) Appl. No.: 16/950,480

(22) Filed: Nov. 17, 2020

(51) Int. Cl. H01F 7/02

(52) U.S. Cl. CPC H01F 7/02

(57) ABSTRACT

An attachable tire protection system. The system attaches to a vehicle. The system has an adjustable mounting arm having a proximal and a distal end. The proximal end is attached to the vehicle steering system and the distal end is attached to a faceplate. A magnet is housed within the faceplate.

### FIELD OF THE DISCLOSURE

The disclosure relates generally to the field of vehicle protection devices. More specifically, the disclosure relates to a magnetic vehicle protection device for individual tires of a vehicle.

### BACKGROUND

Commercial construction companies and other similar service industry companies use work trucks and vans to transport personnel, tools, and materials to and throughout work sites. These work sites tend to become littered with items (e.g., ferro-metallic items) that can be affected by magnetic fields (herein, “magnetic items”). Such magnetic items include nails, screws, bolts, and other small pieces of metal that are on and/or just beneath the ground. These magnetic items are generally very difficult for work vehicles to avoid, and may become lodged within the tires of the work vehicle. This results in damage to the integrity of the tire, which may lead to blowouts and vehicle accidents. In other words, these littered magnetic items pose a significant risk to personnel safety, and may result in significant financial cost if left unaddressed.

There are a few conventional products that attempt to safeguard the vehicle tires from magnetic items on worksites. These conventional devices include, for example, handheld magnetic sweepers, wheeled magnetic sweepers, hanging magnetic sweepers, and tow-behind magnetic sweepers. These conventional devices use magnets to pick up magnetic items as the devices are passed over the magnetic items. However, these conventional devices do not provide each vehicle tire individualized protection.

Conventional magnetic sweeper devices are typically bar shaped and are generally pushed over surfaces manually or are mounted to a vehicle (e.g., via chains or hooks). The conventional devices are then pushed or driven over areas to pick up the littered magnetic objects. However, the conventional devices may miss a portion of the magnetic objects due to human error and/or the turning radius of the vehicle carrying the conventional sweeper. The magnetic tire protection system described herein may resolve these issues at least in part.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

An embodiment of the magnetic tire protection system may have an attachable arm that is mounted to a mounting point of a vehicle. The magnetic tire protection system has a faceplate attached to the arm, and is positioned in front of a tire of the vehicle. The faceplate may have a magnet housed therein for collecting magnetic items. As the vehicle drives through the area having the littered magnetic items, the faceplate may collect the items that are located within a path of the tire.

The magnetic tire protection system may comprise a mounting arm having a connector hold, a release mechanism, and a faceplate that houses a magnet, in an embodiment. The faceplate is removably coupled to the vehicle via the connector hold and release mechanism, which may allow for cleaning of the faceplate after operation. The faceplate may be angled toward the ground to increase the ability of the housed magnet to collect the littered magnetic items before the tires reach the items. The attachment point of the vehicle tire protection system may be located at a suitable point of the vehicle's steering system. This may allow the magnetic tire protection device to follow the path of the tire. A release mechanism may allow for removal of the collected magnetic items. In embodiments, the magnetic items collected by the faceplate may be physically removed therefrom. In other embodiments, a magnetic field being produced by the magnet housed within the faceplate may be canceled to disassociate the magnetic items from the faceplate. By removing the collected items from the faceplate, the release mechanism may allow a user to recycle or reuse the collected items. The selective removal of the collected items may be done at a specific time and/or place in order to implement various safety controls.

The magnetic tire protection system described herein may be used for a plurality of vehicle tires to individually protect each of those tires. Thus, the magnetic tire protection system may fill a void in the market place felt by vehicles that encounter littered magnetic items and debris.

A method for operating the magnetic tire protection system may include the steps of: mounting a mounting arm of the magnetic tire protection system to a steering system of a vehicle, passing the magnetic tire protection system over a magnetic object for collection thereof, detaching the faceplate from the mounting arm, and removing the collected magnetic item.

### BRIEF DESCRIPTION OF THE SEVERAL VIEWS OF THE DRAWINGS

Illustrative embodiments of the present disclosure are described in detail below with reference to the attached drawing figures.

FIG. 1 is a schematic view of a magnetic tire protection system, according to an embodiment.

FIG. 2 is a side view of a faceplate of the magnetic tire protection system of FIG. 1.

FIG. 3 is a front view of a mounting arm of the magnetic tire protection system of FIG. 1.

FIG. 4 is a front view of a magnet of the magnetic tire protection system of FIG. 1.

FIG. 5 is a top view of the faceplate of the magnetic tire protection system of FIG. 1.

FIG. 6 is a schematic view of a magnetic tire protection system, according to another embodiment.

FIG. 7 is a detailed view of electromagnets of the tire protection system of FIG. 6.

FIG. 8 is another detailed view of the electromagnets of the tire protection system of FIG. 6.

FIG. 9 is a flowchart depicting a method of operating the tire protection system of FIG. 1

FIG. 10 is a front view of the tire protection system of FIG. 1 mounted to a steering system of a vehicle.

### DETAILED DESCRIPTION

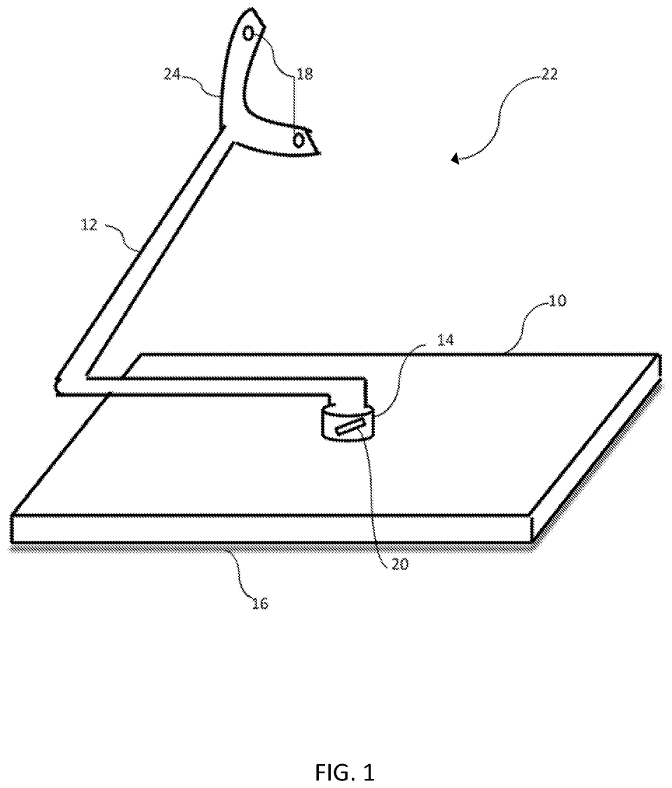

An embodiment 22 of the magnetic tire protection system is shown in FIGS. 1 through 5. The magnetic tire protection system 22 may comprise a faceplate 10 having one or more magnets 16, and a mounting arm 12. The magnetic tire protection system 22 may be selectively attached to a vehicle (e.g., a truck, a car, etc.) whereby the faceplate 10 may be positioned near (e.g., within an inch, which one to six inches) of a ground surface for the attraction of magnetic objects (e.g., ferro-metallic objects, screws, nails, bolt, debris, et cetera). The magnetic objects may be on and/or beneath the ground surface. In operation, the magnetic tire protection system 22 may be configured to collect the magnetic objects that are in a travel path of the tire. As discussed herein, the magnetic tire protection system 22 may be mounted to the vehicle proximate a tire thereof and thus protect that tire of the vehicle. In embodiments, a plurality of the magnetic tire protection systems 22 may be provided for a single vehicle. For example, a magnetic tire protection system 22 may be disposed proximate each front tire of the vehicle. Or, for instance, a vehicle may have a magnetic tire protection system 22 for each of its tires. In some cases, the vehicle may have multiple systems 22 for a single tire (e.g., one system 22 mounted in front the tire and one system 22 mounted behind the tire).

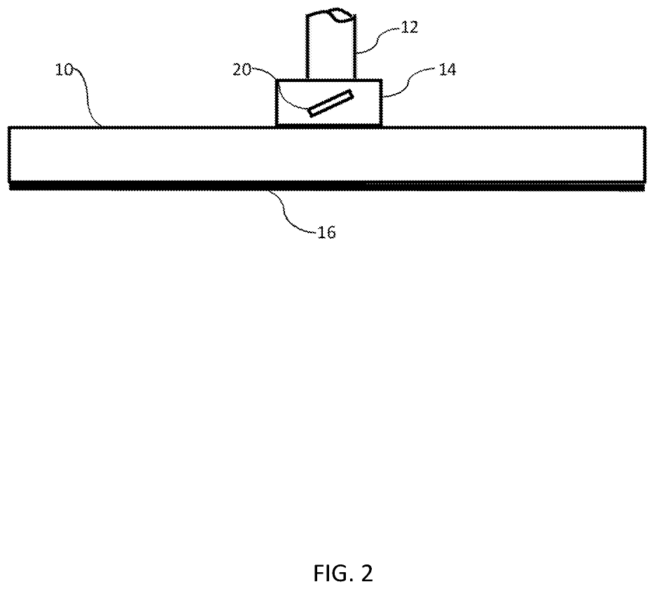

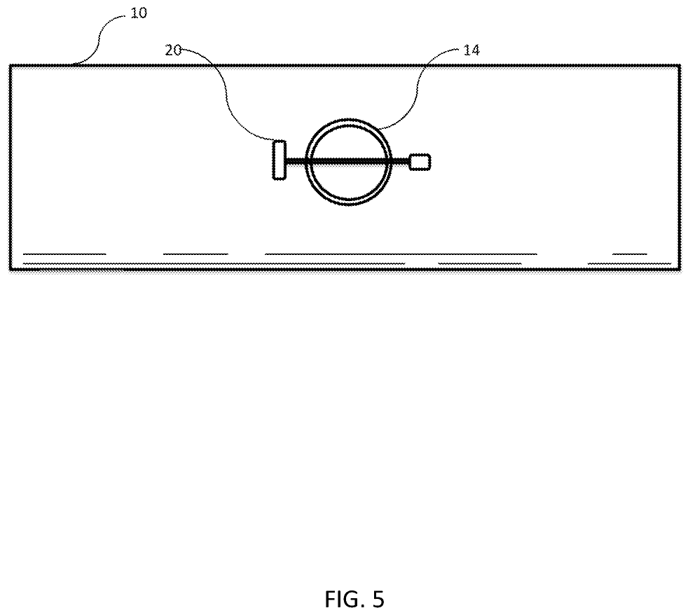

FIG. 1 shows the mounting arm 12 of the magnetic tire protection device 22 being connected to the faceplate 10 by a face plate connector 14. The face plate connector 14 may be any suitable connecting device now known or subsequently developed, such as screws, nails, bolts, hinges, et cetera. In embodiments, the face plate connector 14 may couple the faceplate 10 and the mounting arm 12 via a connection pin 20 (see FIG. 2). The connection pin 20 may be configured to be removable. FIG. 5 shows an example adjustable connector 14 that uses a T-shaped pin and bolt combination as connection pin 20. The artisan will understand the connection mechanism illustrated in the figures is merely exemplary and is not intended to be independently limiting. In some embodiments, the faceplate 10 may be fixedly coupled to the mounting arm 12.

The faceplate 10 may be adjustably (e.g., rotatably) coupled to the mounting arm 12. For example, the faceplate 10 may be coupled to the mounting arm 12 such that a position of the faceplate 10 (e.g., relative to the mounting arm 12, relative to a vehicle tire, relative to the ground surface, etc.) may be selectively altered. For example, in embodiments, the coupling mechanism for coupling the faceplate 10 to the mounting arm may include a movable (such as a spherical or motorized) joint.

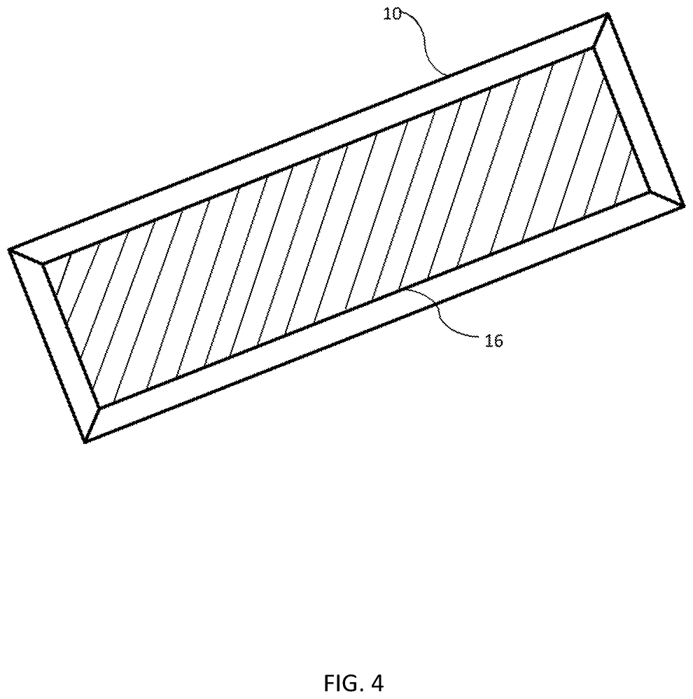

The faceplate 10 may house the magnet 16 in, around, on, and/or within itself, as depicted in FIG. 2. The magnet 16 may be any suitable device for emitting a magnetic field now known or subsequently developed. For example, the magnet 16 may be one or more permanent magnets, such as rare-earth (e.g., neodymium) magnets (see FIG. 4). In embodiments, the magnet 16 may be one or more other types of magnets, such as a non-permanent magnet, as will be discussed in greater detail below.

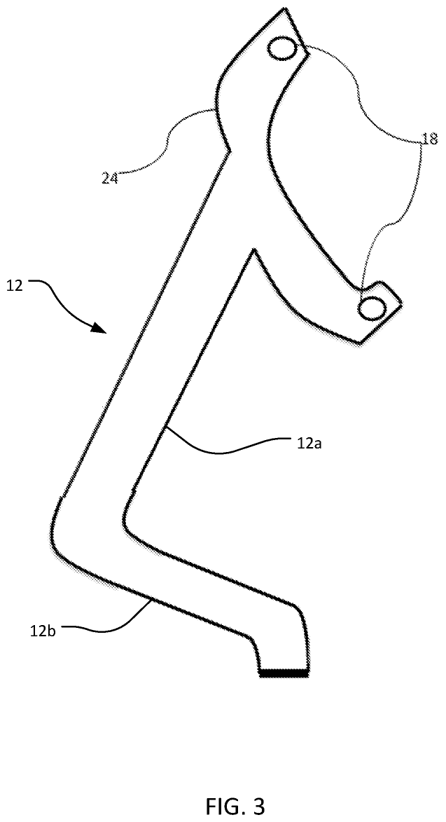

FIG. 3 shows the mounting arm 12 of the magnetic tire protection device 22. The mounting arm 12 may have a shape (e.g., an L or other shape) that is configured to bring the faceplate 10—and the magnet 16 housed therein—within a proximity (e.g., within one or more inches) of the ground surface when the tire protection device 22 is mounted to the vehicle. In embodiments, the mounting arm 12 may be adjustable (e.g., in embodiments the mounting arm 12 may have legs 12a and 12b (FIG. 3) that are pivotally coupled to each other via a spherical or other joint). Such may allow for added flexibility for positioning the faceplate 10 proximate the ground when the device 22 is mounted to the vehicle. The adjustable faceplate 10 and/or the adjustable arm 12 may allow the same protection device 22 to be used with different vehicles having disparately sized tires.

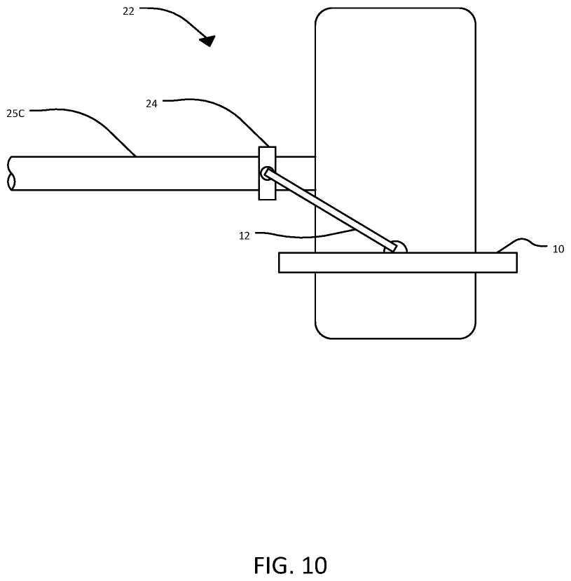

The mounting arm 12 may include an anchor 24 for mounting the device 22 to a vehicle. The anchor 24 may be one or more extensions of the mounting arm 12 and may be configured to wrap around or partially wrap around a portion 25C of the vehicle (e.g., a vehicle steering system, a vehicle axle, et cetera, see FIG. 10). The anchor 24 may include one or more attachable clamps, and/or may be configured in an anchor shape such that the anchor shape itself secures the magnetic tire protection system 22 to the vehicle (e.g., the anchor shape may allow the system 22 to be “snapped” directly onto the vehicle). Alternately or additionally, the anchor 24 may include one or more connection points 18 for coupling (permanently or removably) the magnetic tire protection system 22 to the vehicle. The connection points 18 may be a portion and/or aperture in the anchor 24, and may be configured to retain a connection device (e.g., a bolt, a screw, a nail, an adhesive, a pin, et cetera). In some embodiments, the connection points 18 may include one or more mounting portions that are separate from the anchor 24, such as a device mounted to the vehicle that is configured for being received by the anchor 24.

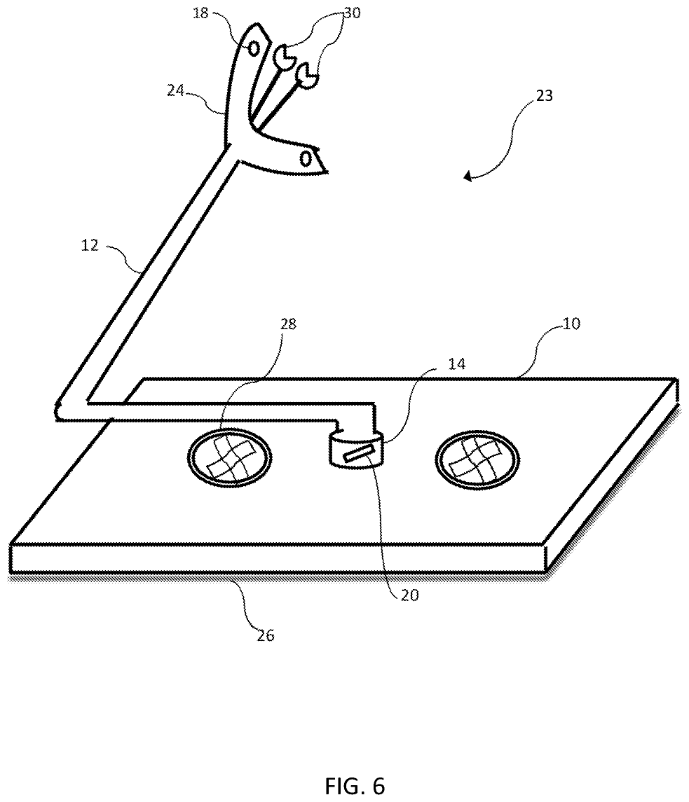

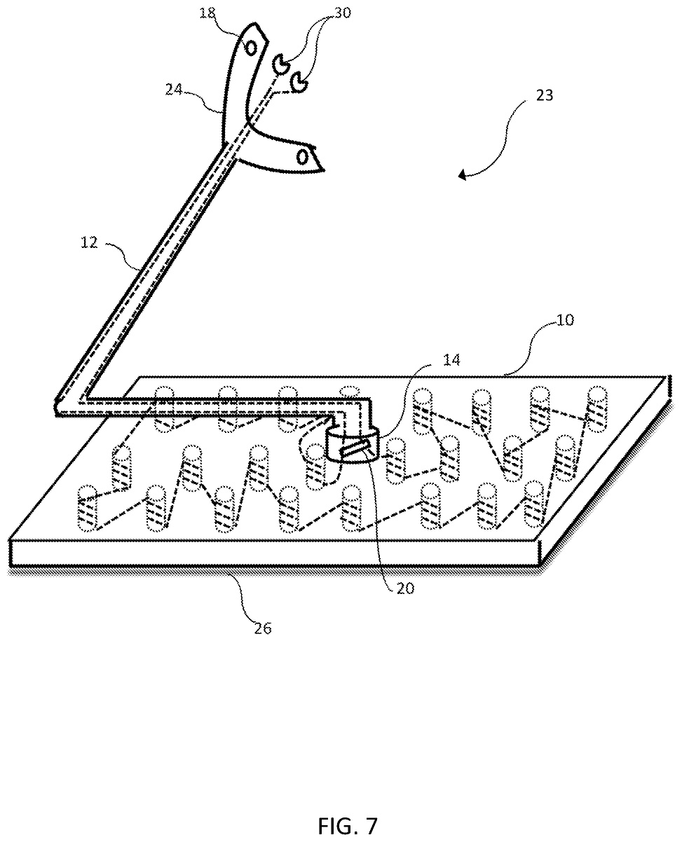

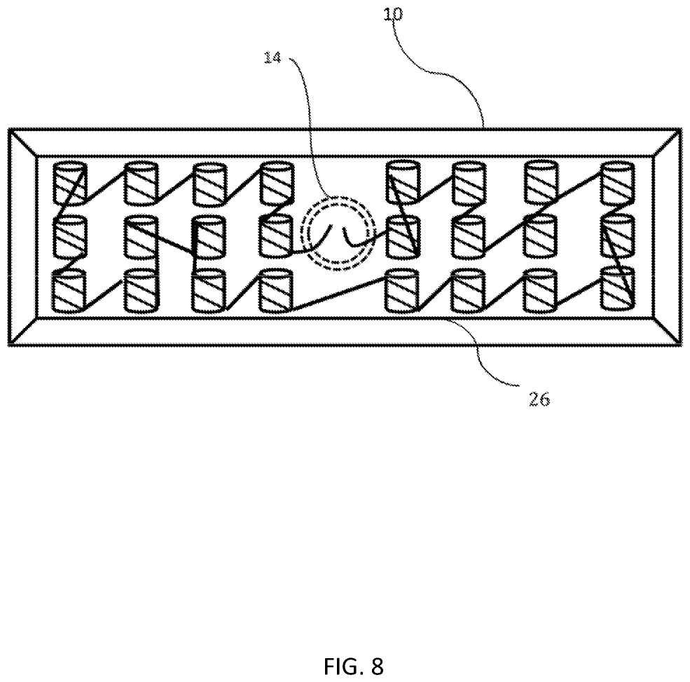

In embodiments, the magnets 16 may be permanent magnets. In other embodiments, non-permanent magnets may alternately or additionally be provided. For example, FIGS. 6-8 show an embodiment 23 of the magnetic tire protection device with one or more non-permanent magnets 26 (e.g., an electromagnet). The system 23 may be substantially similar to the system 22, except as noted and/or shown or as would be inherent. The electromagnet 26 may have a selectively adjustable magnetic field that may be, for example, turned on/off or be adjusted in strength. In use, the electromagnet 26 may be turned off to allow the removal of the magnetic items collected on the face plate 10.

The magnetic tire protection device 23 may include one or more electrical connectors 30 (e.g., wires) to communicate power to the electromagnets 26. The electrical connectors 30 may be associated with the mounting arm 12, such as may be mounted to (e.g., via adhesive) on and/or extend through the mounting arm 12. The electrical connectors 30 may be configured to allow for the electromagnets 26 to be coupled to a power source, such as a battery of the vehicle or other power supply. Alternately or additionally, the electrical connectors 30 may link the electromagnets 26 to a battery of the magnetic tire protection system 23 (e.g., a battery housed by the faceplate 10, a solar power supply of the system 23, et cetera). In embodiments, the electrical connectors 30 may link the electromagnets 26 to one or more switches that may control the function of the electromagnets. For example, the electrical connectors may be linked to a switch housed within the vehicle that is configured to selectively halt the flow of power to the electromagnets 26.

In some embodiments, to accommodate the heat generated by the electromagnets 26, the magnetic protection device 23 may include vents 28. The vents 28 may be, for example, one or more apertures and/or fans placed in proximity to the electromagnets 26 (e.g., within the faceplate 10) for the removal of heat thereof.

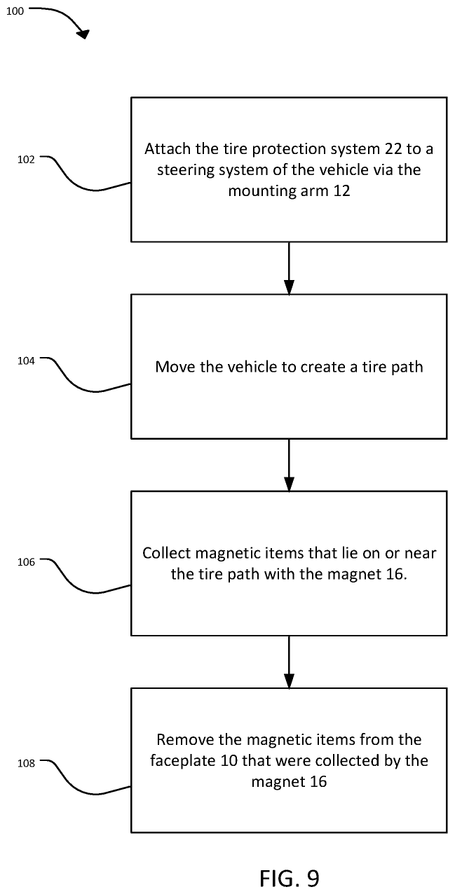

FIG. 9 is a flowchart depicting a method 100 of operating the various embodiments of the magnetic tire protection system described herein. First, at step 102, the magnetic tire protection system may be mounted proximate (e.g., forwardly or rearwardly adjacent) to a tire of the vehicle. For example, the anchor 24 of the mounting arm may be secured to a portion (e.g., a steering system) of the vehicle via the connection points 18. In embodiments, any electrical connectors 30 may likewise be connected to a power supply or other device. Then, at step 104, the vehicle may be driven in a path. At step 106, as the vehicle is being driven, the magnetic field exerted by the magnets (e.g., magnets 16 or 26) of the faceplate 10 may collect one or more magnetic items that are on or adjacent the path of the tire. In other words, the magnets 16 or 26 may collect the magnetic items that are in range of their respective magnetic fields. These magnetic items may thus be rendered unable to damage the tire with which the protection device 22 or 23 is associated. Then, at step 108, the magnetic items that were collected by the faceplate 10 may be removed. For example, the face plate 10 may be uncoupled (e.g., via the connector pin 20) from the mounting arm 12 and a user may use a tool or his or her hand to physically separate the magnetic items from the faceplate 10. As another example, the user may turn off (e.g., via a switch) the magnetic field of the electromagnets 26 to cause the magnetic items to fall off the faceplate. The magnetic items may preferably be removed in a designated area. Once the magnetic items are removed from the faceplate 10, the magnetic tire protection system may be reset to resume operations.

The method 100 may have steps omitted, added, or otherwise modified. For example, the method 100 may include the step of adjusting (e.g., electronically, manually) a position of the faceplate 10 relative to the vehicle tire. As another example, the step of mounting the magnetic tire protection system to a vehicle may further include mounting one or more additional magnetic tire systems to the vehicle (e.g., at one or more tires of the vehicle).

While the components of the tire protection system embodiments described herein may be constructed of any suitable material, it may be desirable to, in embodiments, construct one or more of the components out of a non-magnetic material. For example, it may be advantageous in embodiments to construct both the mounting arm 12 and the faceplate 10 out of a non-magnetic material.

While the disclosure focuses on protecting a vehicle tire from magnetic objects, the artisan will understand from the disclosure herein that the magnetic tire protection embodiments may likewise be used in other applications where it is desirable to collect magnetic objects. Further, while the disclosure uses construction sites as an example of a location where damaging magnetic items may be found, the artisan will understand the systems 22 and 23 are usable to protect vehicle tires from magnetic items on freeways, city streets, and/or other locations.

The artisan will understand that the magnetic tire protection system embodiments disclosed herein may include or have associated therewith electronics not expressly disclosed in the figures. The electronics may, for example, include one or more computers having a processor, a memory, a network interface, et cetera. The electronics may be used to control and modify the operation of the magnetic tire protection system (e.g., may be used to selectively modify the magnetic field of the system 22, may be used to adjust the position of the faceplate 10 from within the vehicle, et cetera). In some example embodiments, the processor or processors may be configured through particularly configured hardware, such as an application specific integrated circuit (ASIC), field-programmable gate array (FPGA, etc., and/or through execution of software to allow the magnetic tire protection system embodiments to function in accordance with the disclosure herein.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the present disclosure. Not all steps listed in the various figures need be carried out in the specific order described.

The disclosure claimed is:

1. A tire protection system, the system being attachable to a steering system of a vehicle, the system comprising:
an adjustable mounting arm having a proximal and a distal end, the proximal end being removably attached to the steering system;
a faceplate coupled to the distal end; and
a magnet housed within the faceplate, the magnet having a magnetic field.

2. The system of claim 1, wherein the faceplate is positioned adjacent a tire of the vehicle.

3. The system of claim 1, wherein the faceplate and the mounting arm are formed of a non-magnetic material.
